(19) United States
(12) Patent Application Publication
(10) Pub. No.: US 2025/0321723 A1
(43) Pub. Date: Oct. 16, 2025

(54) DEPLOYABLE SOFTWARE ARTIFACTS CONTAINING DESIGN-TIME ARTIFACTS

(71) Applicant: SAP SE, Walldorf (DE)

(72) Inventors: Martin Bredy, Mannheim (DE); Ulrich Auer, Hockenheim (DE); Christian Martick, Brandenburg (DE)

(21) Appl. No.: 18/635,993

(22) Filed: Apr. 15, 2024

(51) Int. Cl. G06F 8/41

(52) U.S. Cl. CPC G06F 8/41

(57) ABSTRACT

Described herein are techniques for providing persistent access to versioned design-time artifacts without the need of the design-time environment. A new data structure is introduced for runtime artifacts that allows a compressed version of the design-time artifacts to be stored as part of the runtime artifact. A build-time environment may include a bundler for generating the compressed version and to bundle the compressed version along with the runtime modules as part of the runtime artifact. A runtime environment may include a debundler for decompressing the design-time artifacts so that they may be accessible in the runtime environment.

### BACKGROUND

Unless otherwise indicated herein, the approaches described in this section are not prior art to the claims in this application and are not admitted to be prior art by inclusion in this section.

Enterprise software typically involves three stages and requires three corresponding environments. In the first stage, software is designed in a design-time (design-time) environment. In the second stage, software is built in a build-time (build-time) environment. In the third stage, the executable is deployed to its target system in a run-time (runtime) environment. When software is built into an executable, the software is compiled and optimized such that only the necessary objects and content needed to run the software exists in the executable. However, this approach may lead to issues, particularly in enterprise cloud environments. In an enterprise cloud environment, systems are kept available only as long as needed because it is expensive to keep environments running in the cloud. For example if one wishes to add a new feature to software, a new system would be created in the design-time environment, development of the new feature would be completed in the new system, code changes would be committed, and then the design-time environment would be deleted. As a result, it is difficult to guarantee long-term access to all design-time artifacts without keeping the design-time environment indefinitely which is not practical in enterprise cloud environments.

### BRIEF DESCRIPTION OF THE DRAWINGS

FIG. 1 illustrates a system developing and deploying software according to some embodiments.

FIG. 2 illustrates the data structure of a runtime artifact in the build-time environment according to some embodiments.

FIG. 3 illustrates a method for deploying a runtime artifact according to some embodiments.

FIG. 4 illustrates a method for modifying software according to some embodiments.

FIG. 5 depicts a simplified block diagram of an example computer system 500, which can be used to implement some of the techniques described in the foregoing disclosure.

### DETAILED DESCRIPTION

Described herein are methods and apparatuses to facilitate access to versioned design-time artifacts, thus eliminating the need for direct access to the original design-time environment. Persistent design-time artifacts may be advantageous in cloud environments, particularly enterprise cloud environments. Design-time artifacts are containers that store source code which is used by software developers to build and modify the software. Since access to design-time artifacts is a requirement for software maintenance and improvement, it is important that the design-time artifacts are available. Furthermore, in the context of enterprise software systems, additional requirements, including legal requirements, demand full audit-proof ability which requires access to the design-time artifacts since auditees must be able to provide information on how all runtime artifacts were created and the underlying requirements or change requests they were based on. Achieving this level of traceability and transparency necessitates long-term access to the design-time representations of artifacts, creating a strong need for a scalable solution.

Described herein is a flexible and lightweight mechanism to include relevant information such as versioned design-time artifacts with the deployable/runtime artifacts. A bundler is introduced that is configured to bundle a versioned history of the design-time artifacts needed to build the runtime representations in the runtime artifact. A debundler is also introduced which can debundle the design-time artifacts from the runtime artifact. Once debundled, access to the design-time artifacts can be for various purposes, including reviewing the source code, making changes to the source code, and auditing the source code. The following sections will provide a more detailed introduction to the concept and components involved.

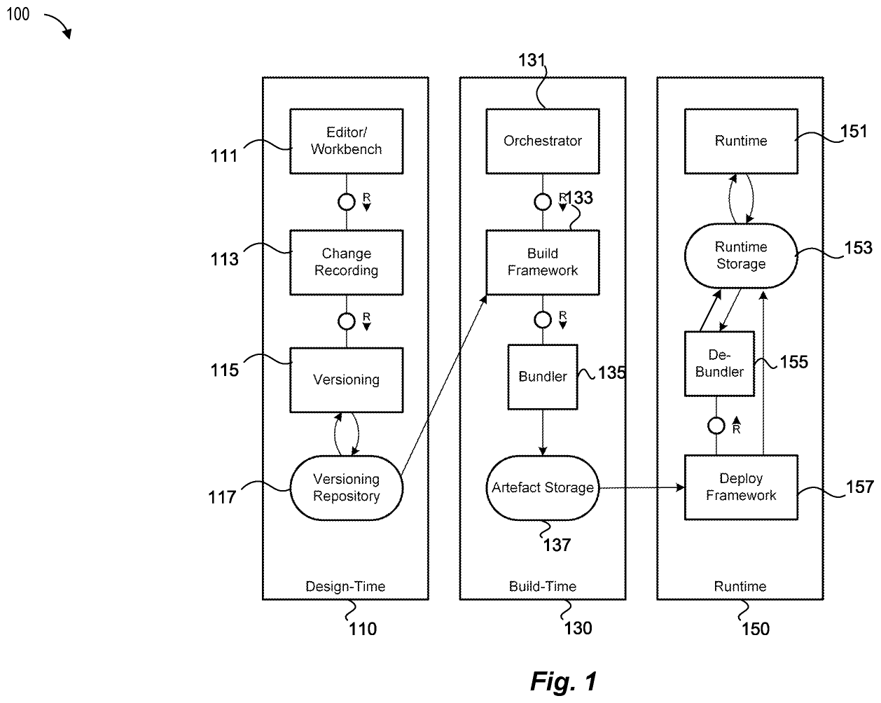

FIG. 1 illustrates a system developing and deploying software according to some embodiments. System 100 includes design-time environment 110, build-time environment 120, and runtime environment 130. Each environment supports a different stage of the software lifecycle. Design-time environment 110 is the environment to generate, review, and modify source code and includes editor/workbench 111, change recording component 113, versioning component 115, and versioning repository 117. In one embodiment, users and developers interact with editor/workbench 111 to generate or change software code which is represented as design-time artifacts. All changes made are recorded leveraging change recording component 113 and changes are committed and versioned into persistency by versioning component 115. Versioned design-time artifacts generated from versioning component 115 are then stored in versioning repository 117. In other words, versioning repository may store multiple versions of the software as versioned design-time artifacts and a user or developer can review different versions of the software by retrieving different design-time artifacts.

Build-time environment 120 is the environment to build the software. Build-time environment 120 orchestrates the transformation of design-time artifacts into deployable and runnable artefacts (this can include compilation processes, bundling processes, etc.). The resulting artefacts from this transformation are stored for further usage in an artefact storage (can be filesystem, remote storage service, database, etc.). Build-time environment 120 includes orchestrator 131, build framework 133, bundler, 135, and artefact storage 137. A user or developer may instruct orchestrator 131 to start the build. Orchestrator 131 may provide instructions to build framework 133 which in turn retrieves the desired version of the software (represented as versioned design-time artifacts) from versioning repository 117 in the design-time environment. Build framework 133 may compile the versioned design-time artifacts into runtime modules for execution. In some embodiments, a design-time artifact may be transformed into a runtime module while in other embodiments, multiple design-time artifacts may be transformed into one or more runtime modules. Build framework 133 may also pass the versioned design-time artifacts retrieved from versioning repository 117 through to bunder 135.

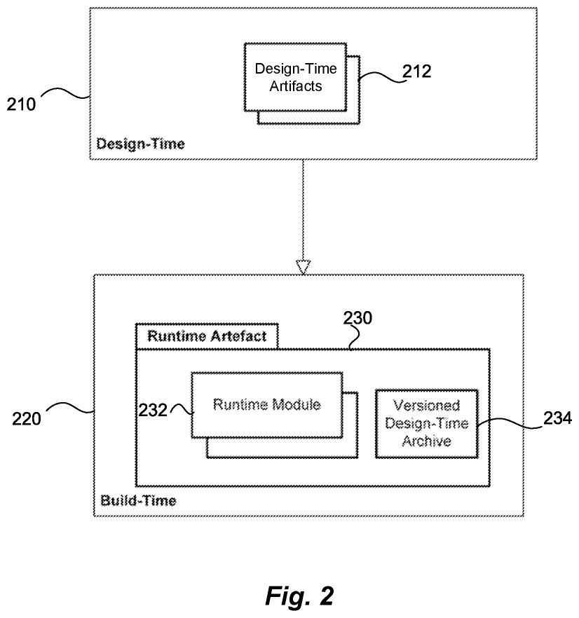

Bundler 135 is configured to bundle the versioned design-time artifacts into a versioned design-time archive. In one embodiment, bundling can include compressing the versioned design-time artifacts so that they take up less space. In another embodiment, bundling can include obfuscating the versioned design-time artifacts to remove certain information from the source code. For example, names of developers, developer comments, developer's private information, or confidential information from the software company that is in the source code can be obfuscated from the versioned design-time artifacts. Since the versioned design-time artifacts are going to be traveling with the executable, it may be advantageous to remove or obfuscate confidential and personal information to prevent the information from being broadcasted broadly. In another embodiment, bundling can include encrypting the versioned design-time artifacts. It may be advantageous to encrypt the versioned design-time artifacts to limit the number of people with access to the versioned design-time artifacts. In one example, cryptographic keys may be utilized to obscure design-time artifacts so that only people with the right credentials can gain access to the versioned design-time artifacts. Once the versioned design-time artifacts have been bundled by bundler 135, bundler 135 may combine the versioned design-time archive with the runtime modules generated by the build framework 133 and create a runtime artifact. The runtime artifact is then transmitted to artefact storage 137 for storage until time for deployment. While bundler 135 shown here is responsible for bundling and creating the runtime artifact, in other embodiments bundler 135 may simply be responsible for bundling the design-time artifacts into versioned design-time archive. Bundler 135 may then transmit the versioned design-time archives to build framework 133, which then creates the runtime artifact and transmits the runtime artifact to artefact storage 137. This embodiment may be preferred in systems that wish to introduce the bundler but also want to minimize changes to an existing system where the build framework is responsible for creating the runtime artifacts. An example of a runtime artifact is described below in FIG. 2.

Runtime environment 130 is the environment to deploy the software. A deployment framework can retrieve the runtime artifacts from artefact storage 137 in the build-time environment and process them in the runtime environment to generate a deployable artifact which is stored in runtime storage 153. Once finished, the runtime 151 can execute the respective artefacts. runtime environment 130 includes runtime 151, runtime storage 153, debundler 155 and deploy framework 157. Deploy framework 157 is configured to deploy software in the target system. Deploy framework 157 may retrieve from the build-time environment, deployable artifacts from artefact storage 137. Once retrieved, deploy framework 157 may generate a deployable artifact which can include a bundle of runtime artifacts. The deployable artifact may be saved in runtime storage 153. In one embodiment, deployment can include unpacking the files from the runtime modules and copying the files to a directory in the operating system. In another embodiment, deployment can include a transformation of creating database representations of the runtime modules which can be versioned in runtime storage 153. In some embodiments where deploy framework 157 is unfamiliar with how to handle the versioned design-time archive within the runtime artifact, debundler 155 can separate the runtime modules from the versioned design-time archive, return the runtime modules to deploy framework 157 and then store the versioned design-time archive in runtime storage 153 where the versioned design-time archive can later be associated with the deployed software. Software that has been deployed resides in runtime storage 153 and the software can be accessed by runtime 151. The deployed software stored in runtime storage 153 can include the versioned design-time archive from the deployable artifact or can be associated with the versioned design-time archive.

Whenever access to the design-time artifacts is required, debundler 155 may retrieve the versioned design-time archive (from deploy framework 157 or alternatively from runtime storage 153 depending on implementation details) and transform the versioned design-time archive into the design-time artifacts, thus making them available for further processing. In one embodiment, debundler 155 may perform these actions in response to a request from runtime 151 to access the design-time artifacts. For example, a user of runtime 151 may request access to the design-time artifacts to review, modify or audit the underlying source code. In systems without a debundler, versioning repository 117 from the design-time environment 110 would need to be accessed to retrieve the design-time artifacts. This creates a strong requirement towards the longevity and accessibility of design-time environment 110 which may be undesirable since enterprise cloud environments prefer to delete the design-time environment after the software has been built so that those resources can be repurposed.

Debundler 155 receives a request from deployed software in runtime storage 153 to debundle a versioned design-time archive stored within runtime storage 153. The request can include the versioned design-time archive to be debundled. In some embodiments, debundler 155 may perform operations to reverse the operations performed by bundler 135. For example if the bundler 135 used a specific technique such as ZIP to compress the design-time artifacts, the reverse technique such as UNZIP may be applied by debundler 155 to decompress the design-time artifacts. As another example if the bunder 135 cryptographically obscured information in the design-time artifacts, the debundler may cryptographically unobscured the information. As another example if the bundler 135 applied encryption to encrypt the versioned design-time archive, then the reverse technique such as a decryption can be applied to decrypt the versioned design-time archive.

In one embodiment, the request received by debundler 155 may further include security information for accessing versioned design-time archive. For example, the security information can include credentials of the requestor which debundler 155 may check against a white list to determine whether the requester has permission to access the design-time artifacts. As another example, the security information can include a cryptographic key that may be used to decrypt or unobscured the versioned design-time archive to access the design-time artifacts. In yet other examples, other information may be provided in the debundler request that is needed to access the design-time artifacts in the versioned design-time archive.

Once debundler 155 has debundled the design-time artifacts from the versioned design-time archive, debundler 155 returns the design-time artifacts to runtime storage 153, which in turn may allow a user of runtime 151 to access the design-time artifacts. In one embodiment, the user may review the design-time artifacts to better understand the underlying logic. In another embodiment, the user may audit the design-time artifacts to see whether they satisfy audit criteria. In yet another embodiment, the user may wish to make changes to the design-time artifacts. If the design-time environment 110 has already been deleted, the design-time artifacts debundled from the versioned design-time archive may be utilized to recreate the design-time environment and the versioning repository. The user may then utilize an editor or workbench to make changes to the software code and commit the changes to the versioning repository. The committed changes can then be built in the build-time environment and then deployed in the runtime environment. In other embodiments, different implementation details may arise but the bundler 135 is to bundle the design-time artifacts into the versioned design-time archive and the debundler 155 is to debundle the versioned design-time archive back into the design-time artifacts.

FIG. 2 illustrates the data structure of a runtime artifact in the build-time environment according to some embodiments. As shown, design-time environment 210 includes design-time artifacts 212. The design-time artifacts 212 may be stored in a versioning repository as shown in FIG. 1. Build-time environment 220 may receive design-time artifacts 212 and build runtime artifact 230 from design-time artifacts 212. As shown, runtime artifact 230 includes runtime modules 232 and versioned design-time archive 234. In one embodiment, there is a 1:1 mapping between design-time artifacts and runtime modules. In other embodiments, there is a n:m mapping between design-time artifacts and runtime modules. For example, the build-time environment 220 may build four design-time artifacts which results in three runtime modules. Build-time environment 220 may also generate versioned design-time archive 234 by bundling design-time artifacts 212 into a compressed (and optionally secured) format which improves efficiency when transmitting the runtime artifact 230 to different modules and environments. As shown, runtime artifact essentially includes the runtime modules that were generated by building design-time artifacts 212 and also a versioned design-time archive that stores the design-time artifacts themselves in a compressed format.

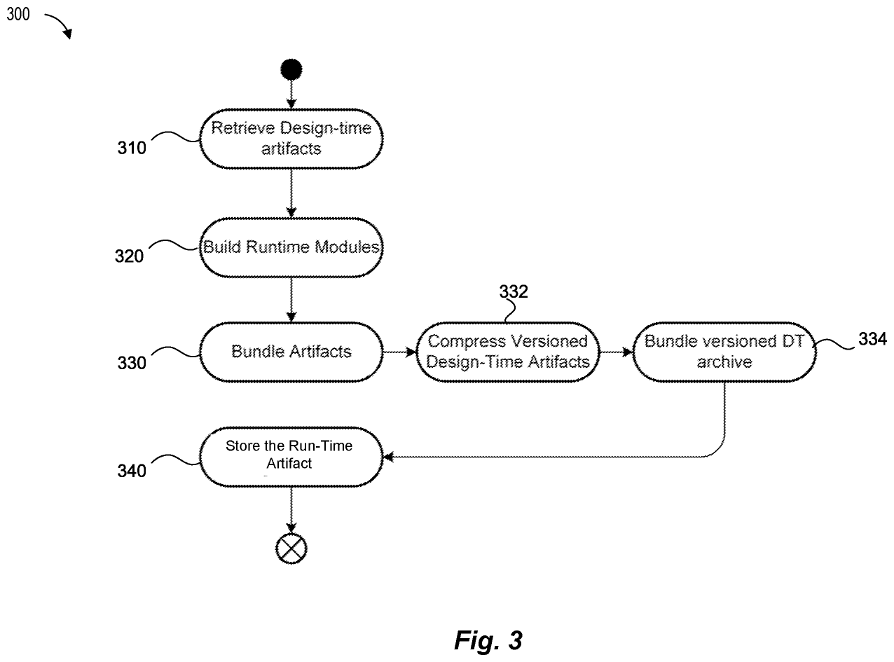

FIG. 3 illustrates a method for deploying a runtime artifact according to some embodiments. The method can be implemented in computer readable code that is stored in processors supporting a build-time environment. Workflow 300 starts with retrieving design-time artifacts at step 310. The design-time artifacts may be retrieved from the design-time environment, for example a versioning repository in the design-time environment. Workflow 300 then continues by building the runtime modules at step 320. The runtime modules may be derived from the design-time artifacts and there may be a 1:1 or n:m mapping between the runtime modules and the design-time artifacts. Once the runtime modules have been created, workflow 300 continues with a bundling operation at step 330. Bundling operation 330 may be broken up into two steps, the first step 332 being compressing the versioned design-time artifacts into a versioned design-time archive, and the second step 334 being bundling the versioned design-time archive with the runtime modules to form the runtime artifact. In step 332, the versioned design-time artifacts are compressed into a versioned design-time archive. In some embodiments, the versioned design-time artifacts may also be encrypted or obfuscated. At step 334, the versioned design-time archive is bundled with the runtime modules to form the runtime artifact. This can include storing both the runtime modules and the versioned design-time archive into a container of the runtime artifact. Once the runtime artifact has been generated, workflow 300 can continue by storing the runtime artifact. In one embodiment, the runtime artifact can be stored in an artifact storage in the build-time environment. runtime environments can subsequently retrieve the runtime artifact from the build-time environment and deploy the runtime artifact to the target runtime.

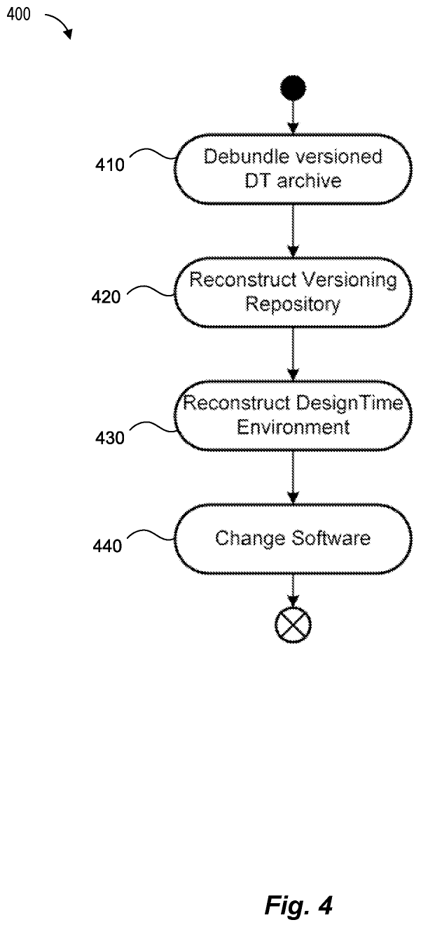

FIG. 4 illustrates a method for modifying software according to some embodiments. The method can be implemented in computer readable code that is stored in processors supporting a run-time environment and a design-time environment. In response to a request to make changes to the software, workflow 400 starts by debundling the versioned design-time archive into design-time artifacts at step 410. Debundling can include performing operations that reverse the operations performed during bundling. These operations can include decompression, decryption, de-obfuscation, and others. In some embodiments, there can be a 1:1 mapping between operations performed during bundling and operations performed during debundling. Once debundled workflow 400 continues by reconstructing the versioning repository at step 420. Reconstruction of the versioning repository can include storing the versioned design-time artifacts recovered from the debundling process. Once the versioning repository has bene reconstructed, workflow 400 continues by reconstructing the design-time environment in which code changes can be made. The design-time environment may look similar and have similar components as the design-time environment shown in FIG. 1. Once the design-time environment has been reconstructed, workflow 400 continues by making changes to the software in the design-time environment at step 440.

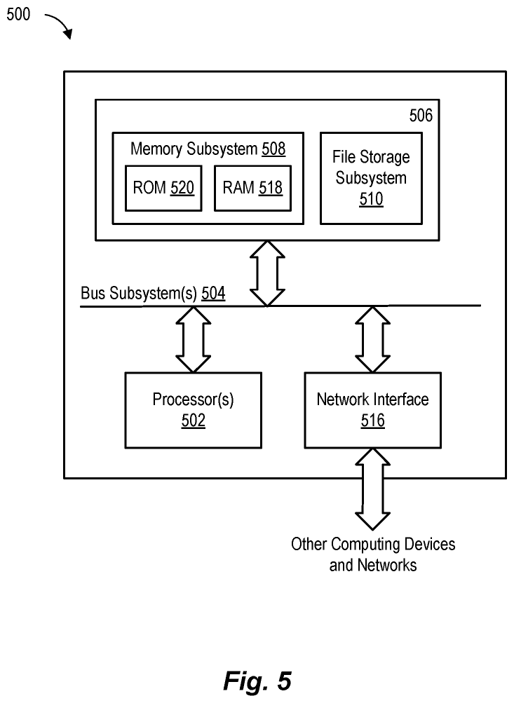

FIG. 5 depicts a simplified block diagram of an example computer system 500, which can be used to implement some of the techniques described in the foregoing disclosure. As shown in FIG. 5, system 500 includes one or more processors 502 that communicate with several devices via one or more bus subsystems 504. These devices may include a storage subsystem 506 (e.g., comprising a memory subsystem 508 and a file storage subsystem 510) and a network interface subsystem 516. Some systems may further include user interface input devices and/or user interface output devices (not shown).

Bus subsystem 504 can provide a mechanism for letting the various components and subsystems of system 500 communicate with each other as intended. Although bus subsystem 504 is shown schematically as a single bus, alternative embodiments of the bus subsystem can utilize multiple buses.

Network interface subsystem 516 can serve as an interface for communicating data between system 500 and other computer systems or networks. Embodiments of network interface subsystem 516 can include, e.g., Ethernet, a Wi-Fi and/or cellular adapter, a modem (telephone, satellite, cable, etc.), and/or the like.

Storage subsystem 506 includes a memory subsystem 508 and a file/disk storage subsystem 510. Subsystems 508 and 510 as well as other memories described herein are examples of non-transitory computer-readable storage media that can store executable program code and/or data that provide the functionality of embodiments of the present disclosure.

Memory subsystem 508 comprise one or more memories including a main random access memory (RAM) 518 for storage of instructions and data during program execution and a read-only memory (ROM) 520 in which fixed instructions are stored. File storage subsystem 510 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 500 is illustrative and many other configurations having more or fewer components than system 500 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a method comprising receiving, in a build-time environment, a request to generate a runtime artifact; retrieving, from a version repository in a design-time environment, a plurality of design-time artifacts associated with the runtime artifact; building, in the build-time environment, a plurality of run-time modules based on the plurality of design-time artifacts; bundling, in the build-time environment, the plurality of design-time artifacts into a versioned design-time archive; generating, in the build-time environment, the runtime artifact from the plurality of run-time modules and the versioned design-time archive; and storing the runtime artifact in an artifact storage of the build-time environment.

In one embodiment, bundling includes compressing the plurality of design-time artifacts into the versioned design-time archive.

In one embodiment, bundling includes obfuscating personal information from the plurality of design-time artifacts before storage in the versioned design-time archive.

In one embodiment, bundling includes bundling includes encrypting the plurality of design-time artifacts before storage in the versioned design-time archive.

In one embodiment, the method further comprises receiving, in a runtime environment, a request to deploy the runtime artifact; retrieving, in the runtime environment, the runtime artifact from the artifact storage in the build-time environment; storing, in the runtime environment, the runtime artifact in runtime storage; and deploying, in the run-time environment, the runtime artifact.

In one embodiment, the method further comprises receiving, in the runtime environment, a request to access the design-time artifacts; and debundling, in the runtime environment, the versioned design-time archive into a plurality of design-time artifacts.

In one embodiment, debundling includes restoring the plurality of design-time artifacts from the versioned design-time archives by reversing the operations performed from the bundling.

In one embodiment, the method further comprises launching, in the runtime environment, a browser application to view the plurality of design-time artifacts.

In one embodiment, the design-time environment has previously been deleted and the plurality of design-time artifacts are used in reconstructing the design-time environment.

In some embodiments the present disclosure includes a system comprising one or more processors; a non-transitory computer-readable medium storing a program executable by the one or more processors, the program comprising sets of instructions for: receiving, in a build-time environment, a request to generate a runtime artifact; retrieving, from a version repository in a design-time environment, a plurality of design-time artifacts associated with the runtime artifact; building, in the build-time environment, a plurality of run-time modules based on the plurality of design-time artifacts; bundling, in the build-time environment, the plurality of design-time artifacts into a versioned design-time archive; generating, in the build-time environment, the runtime artifact from the plurality of run-time modules and the versioned design-time archive; and storing the runtime artifact in an artifact storage of the build-time environment.

In some embodiments, the present disclosure includes a non-transitory computer-readable medium storing a program executable by one or more processors, the program comprising sets of instructions for: receiving, in a build-time environment, a request to generate a runtime artifact; retrieving, from a version repository in a design-time environment, a plurality of design-time artifacts associated with the runtime artifact; building, in the build-time environment, a plurality of run-time modules based on the plurality of design-time artifacts; bundling, in the build-time environment, the plurality of design-time artifacts into a versioned design-time archive; generating, in the build-time environment, the runtime artifact from the plurality of run-time modules and the versioned design-time archive; and storing the runtime artifact in an artifact storage of the build-time environment.

What is claimed is:

1. A method, comprising:
receiving, in a build-time environment, a request to generate a runtime artifact;
retrieving, from a version repository in a design-time environment, a plurality of design-time artifacts associated with the runtime artifact;
building, in the build-time environment, a plurality of run-time modules based on the plurality of design-time artifacts;
bundling, in the build-time environment, the plurality of design-time artifacts into a versioned design-time archive;
generating, in the build-time environment, the runtime artifact from the plurality of run-time modules and the versioned design-time archive; and
storing the runtime artifact in an artifact storage of the build-time environment.

2. The method as in claim 1, wherein bundling includes compressing the plurality of design-time artifacts into the versioned design-time archive.

3. The method as in claim 1, wherein bundling includes obfuscating personal information from the plurality of design-time artifacts before storage in the versioned design-time archive.

4. The method as in claim 1, wherein bundling includes encrypting the plurality of design-time artifacts before storage in the versioned design-time archive.

5. The method as in claim 1, further comprising:
receiving, in a runtime environment, a request to deploy the runtime artifact;
retrieving, in the runtime environment, the runtime artifact from the artifact storage in the build-time environment;
storing, in the runtime environment, the runtime artifact in runtime storage; and
deploying, in the run-time environment, the runtime artifact.

6. The method as in claim 5, further comprising:
receiving, in the runtime environment, a request to access the design-time artifacts; and
debundling, in the runtime environment, the versioned design-time archive into a plurality of design-time artifacts.

7. The method as in claim 6, wherein debundling includes restoring the plurality of design-time artifacts from the versioned design-time archives by reversing the operations performed from the bundling.

8. The method as in claim 6, further comprising:
launching, in the runtime environment, a browser application to view the plurality of design-time artifacts.

9. The method as in claim 6, wherein the design-time environment has previously been deleted and the plurality of design-time artifacts are used in reconstructing the design-time environment.

10. A system comprising:
one or more processors;
a non-transitory computer-readable medium storing a program executable by the one or more processors, the program comprising sets of instructions for:
receiving, in a build-time environment, a request to generate a runtime artifact;
retrieving, from a version repository in a design-time environment, a plurality of design-time artifacts associated with the runtime artifact;
building, in the build-time environment, a plurality of run-time modules based on the plurality of design-time artifacts;
bundling, in the build-time environment, the plurality of design-time artifacts into a versioned design-time archive;
generating, in the build-time environment, the runtime artifact from the plurality of run-time modules and the versioned design-time archive; and
storing the runtime artifact in an artifact storage of the build-time environment.

11. The system of claim 10, wherein bundling includes compressing the plurality of design-time artifacts into the versioned design-time archive.

12. The system of claim 10, wherein bundling includes obfuscating personal information from the plurality of design-time artifacts before storage in the versioned design-time archive.

13. The system of claim 10, wherein bundling includes encrypting the plurality of design-time artifacts before storage in the versioned design-time archive.

14. The system of claim 10, further comprising:
receiving, in a runtime environment, a request to deploy the runtime artifact;
retrieving, in the runtime environment, the runtime artifact from the artifact storage in the build-time environment;
storing, in the runtime environment, the runtime artifact in runtime storage; and
deploying, in the run-time environment, the runtime artifact.

15. The system of claim 14, further comprising:
receiving, in the runtime environment, a request to access the design-time artifacts; and
debundling, in the runtime environment, the versioned design-time archive into a plurality of design-time artifact.

16. The system of claim 15, wherein debundling includes restoring the plurality of design-time artifacts from the versioned design-time archives by reversing the operations performed from the bundling.

17. The system of claim 15, further comprising:
launching, in the runtime environment, a browser application to view the plurality of design-time artifacts.

18. The system of claim 15, wherein the design-time environment has previously been deleted and the plurality of design-time artifacts are used in reconstructing the design-time environment.

19. A non-transitory computer-readable medium storing a program executable by one or more processors, the program comprising sets of instructions for:
receiving, in a build-time environment, a request to generate a runtime artifact;
retrieving, from a version repository in a design-time environment, a plurality of design-time artifacts associated with the runtime artifact;
building, in the build-time environment, a plurality of run-time modules based on the plurality of design-time artifacts;
bundling, in the build-time environment, the plurality of design-time artifacts into a versioned design-time archive;
generating, in the build-time environment, the runtime artifact from the plurality of run-time modules and the versioned design-time archive; and
storing the runtime artifact in an artifact storage of the build-time environment.

20. The non-transitory computer-readable medium of claim 19, wherein bundling includes compressing the plurality of design-time artifacts into the versioned design-time archive.
